(19) United States
(12) Patent Application Publication
(10) Pub. No.: US 2017/0251257 A1
(43) Pub. Date: Aug. 31, 2017

(54) System and method for aggregating and displaying media from multiple cloud services

(71) Applicant: Dermot OBrien Apps, LLC, Singer Island, FL (US)

(72) Inventor: Dermot OBrien, North Palm Beach, FL (US)

(73) Assignee: Dermot OBrien Apps, LLC, Singer Island, FL (US)

(21) Appl. No.: 15/330,950

(22) Filed: May 28, 2014

(51) Int. Cl. H04N 21/462; H04N 21/61; H04N 21/437; H04N 21/482; H04N 21/475; H04N 21/258; H04N 21/472; H04N 21/274; H04N 21/466; H04L 29/08; H04N 21/658

(52) U.S. Cl. CPC H04N 21/4622; H04L 67/10; H04L 67/306; H04N 21/6125; H04N 21/6175; H04N 21/437; H04N 21/4825; H04N 21/6582; H04N 21/25891; H04N 21/47217; H04N 21/274; H04N 21/47205; H04N 21/4668; H04N 21/4753

(57) ABSTRACT

A computer implemented system and process for aggregating files from multiple Cloud servers provides into one or more seamless virtual directories. File types can be combined to create unique multimedia Shows, with added special effects and transitions. The Shows can be streamed to multiple device types or saved for later viewing. Shows can be pushed out to devices, viewed on-demand or by schedule and Cloud subscribers can change show content by changing media residing in their individual Clouds.

### FIELD OF THE INVENTION

The present disclosure relates to a computer implemented method for aggregating digital content, preferably media content such as audio, video, or image files, residing on a multitude of Cloud storage devices or Cloud subscription service sites.

More specifically, the present disclosure aggregates digital files into a virtual file system residing on a multiple of Internet accessible Cloud storage devices or within Cloud-based paid subscription services.

Most specifically, the invention is directed toward a computer implemented embodiment wherein data can be combined to create mixed media Shows, whereby the mixed media shows are viewable on Internet accessible computing devices with a compatible media player; or alternatively the shows can be pushed to remote devices for viewing.

### BACKGROUND OF THE INVENTION

Cloud Computing has different meanings to different people but as used in this invention, Cloud computing refers to on-demand access to remote computing services or storage devices over the Internet or local network. A more technical definition of Cloud Computing is:

(A) model for enabling ubiquitous, convenient, on-demand network access to a shared pool of configurable computing resources (e.g., networks, servers, storage, applications, and services) that can be rapidly provisioned and released with minimal management effort or service provider interaction. This Cloud model promotes availability and is composed of five essential characteristics, three service models, and four deployment models.¹ ¹Peter Mell and Tim Grance, The NIST Definition of Cloud Computing (Draft) (January 2011) (NIST Definition), at 2, available at http://csrc.nist.gov/publications/draft/800-145/Draft-SP-800-145_Cloud-definition.pdf.

Although the concept of Cloud Computing has been around for decades, it was not until recently that the high quality reliability and throughput combined with economies of scale price reductions made Cloud Computing feasible.

The conveniences of this technology and the ease with which an end user can access, or providers can push, various types of data out to the public have caused the proliferation of Cloud Computing and Cloud Service Providers.

Most modern computing and mobile devices take advantage of the Cloud allowing users to store their files as easily as if they resided on their local hard drives. Sharing user-generated content through sites like YOUTUBE or FACEBOOK, has become ubiquitous and the Cloud Subscription Services, such as PANDORA or SPOTIFY provide access to thousands of musical artists without the need to purchase, download, or store files locally for later playback. Web appliances like APPLE TV, ROKU or GOOGLE TV, are replacing cable-boxes as primary streaming media sources in a growing number of homes.

Unfortunately, while the ability to access and stream remote media content has become widespread, each Cloud Service (more formally identified as Cloud Service Providers) remains fragmented, isolated from each other.

Copyright laws, licensing agreements, and data security concerns among other reasons, force Cloud Service Providers into “walled gardens,” where users have access only to material from that specific Cloud Service Provider. If the user wishes to access media from a different Cloud, they must leave the walled garden and enter the other Cloud's walled garden.

Moving content between clouds is either prevented or requires duplication so that users must first download content from one Cloud to their local machine and then upload the content to the other Cloud.

Because of the walled garden model, users often find themselves with data in multiple Clouds requiring multiple applications to view their media content. Music may be stored on a personal Cloud drive while images are uploaded to a photo or social media site and videos are deposited onto a video-streaming site. Media may also be duplicated on multiple Cloud services.

For Clouds with licensed content, each may have unique offerings not available to other Providers, as well as having duplicated content. For example, two subscription-based music services may have the exclusive right to host certain musical artist's work requiring that users subscribe to both Clouds in order to listen to both artists, yet a large portion of the music catalogs for both services are the same.

U.S. Patent Publication Number U.S. 2014/0108621 A1 System And Method For Internet Services Aggregation merely accesses multiple social media accounts and retrieves text bases user information such as Twitter or Facebook feeds, but does not contemplate Cloud System Services file aggregation or media Shows.

U.S. Patent Publication Number U.S. 2013/0291087 A1 Systems And Methods For Integrating Cloud Services With Information Management Systems accesses multiple Networked services and Cloud services but only to retrieve log data which is communicated to an internal information management system for aggregating the log data.

U.S. Patent Publication Number U.S. 2013/0144939 A1 Methods, Devices, And Systems For Enabling a Personal Cloud-Computing Environment With Ubiquitous Mobile Access And Source-Independent, Automated Data Aggregation contemplates determining, based on whether to perform a local file-access operation to perform a remote file-access operation on a remote storage element in on a mobile cloud computing device.

Therefore, the object of this disclosure is to satisfy an unmet need in the art by providing a computer implemented system and method for aggregating content from multiple Cloud computing services into one or more virtual directories, where data can be remixed into unique media shows for viewing on a multiple of computing devices.

### SUMMARY OF THE INVENTION

The present system and method is for aggregating content from multiple Cloud computing services into one or more virtual directories, where data can be remixed into unique media shows for viewing on a multiple of computing devices.

In one embodiment, a user chooses Cloud services from which they want to access available media files. A Cloud Aggregation Server retrieves the data location in the Cloud directories and creates symbolic or other virtual links to each file and aggregates them into one or more virtual drive catalogs for viewing by users on enabled devices.

In one embodiment, the virtual links pointing to Cloud files are filtered to remove duplicate data or non-media files.

In another embodiment, users choose the global preferences for the de-duplication process, for example, deciding which Cloud has priority, or whether to choose the latest file or the largest file size when duplicates are found.

In another embodiment, various media located in different Clouds can be mixed into a unique multimedia Show, streamed to a user's computing device. The Show can be saved and stored for later use.

In a third embodiment, a user's multimedia Shows can be shared with other users or pushed to multiple local machines for automated viewing.

Each of these embodiments should be interpreted as illustrative and non-limiting.

### Use of the Present System

A user accesses an Internet enabled computing device, such as a personal computer, web appliance such as GOOGLE TV or ROKU, or a mobile devices, which interfaces with an application server.

On the initial login, the user will choose the appropriate Clouds he or she wishes to access, and provides login information which is stored on the Cloud Aggregation Server along with the user's application passwords and other profile information. The information can be saved locally or on the Cloud Aggregation Server for use by other enabled devices. In a preferred embodiment, a user can create multiple profiles, each with different Cloud access and global preferences.

The virtual media catalog can be viewed in numerous ways, including a hierarchical directory structure, any of the Clouds interfaces, or a multiple of designs that show file metadata, related images or related web content. Files can be viewed through any application that supports that file type, but a preferred embodiment includes a universal media player with audio and video codecs for multiple file types.

Users can create content playlists and view them sequentially or randomly as presentations, or create Shows, viewed through the universal player.

Shows can consist of a multiple of visual media files, such as, but not limited to, sections of visual media files or whole visual media files, mixed sequentially, concurrently or both, to create a unique Show; with or without audio playing concurrently.

Audio can also me remixed, using sections of an audio file, or one or more complete audio files, played sequentially or concurrently, creating an audio mix that can be played alongside the visual media Show.

Each media component (i.e. images, video, music) can be set with visual or audio effects or other conditions. For example, images can be set for slide duration and transition, or a video can be played with or without sound and may have added visual effects such as changes in contrast, color, or vibrancy or change to black and white. The system can also add additional visuals, such as picture frames around each image. Some content types, like music files, may be streamed alongside the visual show as an additional layer. The song information, including artists and track name, can be superimposed over the video or pictures in the presentation

In an embodiment, a special effect allow the Show's viewing screen to be sectioned into two or more parts, each playing a streaming media file or Show; with or without audio; audio being chosen from one or more of the split screen streaming media files or Shows, or alternatively any audio file available from connected Cloud Service Providers.

Shows can be saved for future use or combined into new playlists, or exported into video format to be played outside of the system.

### BRIEF DESCRIPTION OF THE DRAWINGS

FIG. 1 illustrates, diagrammatically, a Cloud Aggregation Server accessing multiple Cloud Computing Systems, creating symbolic links to the content and aggregating the links into a virtual file system.

FIG. 2 illustrates diagrammatically multiple file types from multiple Cloud Service Providers aggregated and generated into a mixed multimedia presentation, which may be viewed through a hardware or software player; and

FIG. 3 illustrates diagrammatically pushing Shows out to multiple local devices, with changes to a Show's content made by users changing media content in various Clouds.

### DETAILED DESCRIPTION

Cloud computing architecture has two main components: a front end and back end. The front end encompasses an application for collecting input from the user and processing it to conform to the specification of the back end, where the data resides, such as in the Cloud.

In order to allow software applications on the front end to access content on the back end, the Cloud Service Providers usually provide APIs (application program interfaces) so that third party developers can have a secure conduit to the data. APIs specify the manner in which the application should interact with the Cloud and the limits of that interaction, allowing the data to flow freely and securely.

The embodiments of the present invention contemplate accessing Clouds using APIs as the preferred method, but the invention is not limited to this approach as a means for accessing Cloud-based media.

In the following detailed description, reference is made to the accompanying drawings. For purposes of illustration, the drawings contemplate use of the disclosure for media files; however, the present disclosure is not limited thereto and can be changed and modified to include multiple types of content.

It will be understood by those within the art that, in general, the term “including” used herein should be interpreted as “including but not limited to;” the term “having” should be interpreted as “having at least,” the term “includes” should be interpreted as “includes but is not limited to,” and the term “such as” should be interpreted as “an example of, but not limited to” and so on.

Hereinafter, a System And Method For Aggregating And Displaying Media From Multiple Cloud Services will be described in accordance with a first embodiment and where additional embodiments or preferred embodiments are discussed, they will be noted.

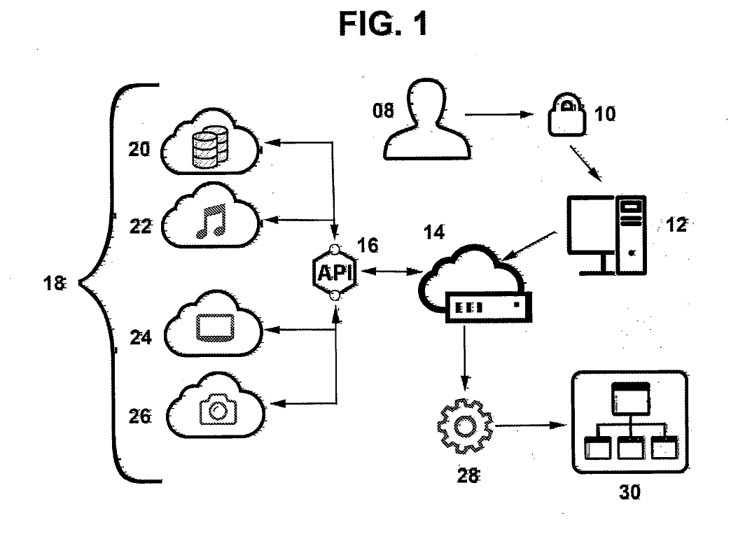

FIG. 1 shows a User 8 entering login and security credentials 10 to access the software interface on computing device 12.

A user chooses which Cloud Services (collectively 18) that a user wishes to access, and provides the login information for each Cloud. Many publicly available Clouds do not require logins, although a login is often available or desired for social media and sharing or for saving favorite media, creating playlists or entering comments, which can be made available to the user in the invention.

The login information is stored on a Cloud Server or local machine, which can be accessed by the Aggregation Server 14.

In an embodiment, users can create multiple profiles with a plurality of configurations and preferences.

The Cloud Aggregation Server 14 uses the profile information or user entered information to make an API call 16 to a plurality of accessible Cloud Service Providers. Examples of Cloud Service Providers include, but are not limited to, Storage Clouds 20 that contain various types of user files, Subscription Cloud Services 22, such as those that provide streaming audio of major music artists, Video Content Clouds 24, where user-generated video is stored and streamed for public viewing, and Social Media Cloud sites 26.

FIG. 1 shows Cloud Aggregation Server 14 making an API call 16, using security login information provided by the user, to multiple Cloud Services 20, 22, 24, 26.

A Cloud Aggregation Server 14 or user device computing process retrieves file location path for files on accessible Cloud Service Provider Servers and creates symbolic links indicating paths to the files.

Software within Cloud Aggregation Server 14 runs processes 28 on the data, including aggregation and removes symbolic links pointing to duplicate files, the remaining files chosen based upon user preferences or default processes, such as, but not limited to, connection speed or connection quality, and then creates Virtual Directory 30, with the resulting symbolic links, viewed on device 12.

Virtual Directories are not limited to hierarchical directory forms. Files can be viewed as interactive graphical user interfaces displaying additional media file data from metadata or other embedded data such as digital watermark.

In an embodiment, the Cloud Aggregation Server 14 makes periodic calls to connected Cloud Services and updates the duplicate file results.

Other devices can then access the varying profiles stored on Cloud Aggregation Server 14 and receive the aggregated file catalog in the Virtual Directory 30.

To play a media file, i.e. a song, video or image, a user selects a media file by selection of its corresponding symbolic link in the Virtual Directory 30.

Cloud Aggregation Server 14 will make an API call to the Cloud Service Provider hosting the media file, making a request that the file be streamed, or otherwise pulled in streaming format to the Cloud Aggregation Server 14 and routed to the user's media player device. Although a particular embodiment, and Aggregation server 14 is not required as API calls and required computer processes can be built into a user device application.

In a further embodiment, the Cloud Aggregation Server 14 will periodically, or by user request, maintain “saved-states,” which save any required information for the user to open a media player on other devices and continue playing the media at the point indicated by the saved-state. For example, a user midway through watching a video on a mobile phone, can turn-off the device and continue watching from the same point on their web appliance or computer.

Saved-states can be stored on a Cloud Server and used to synchronize a plurality of user devices.

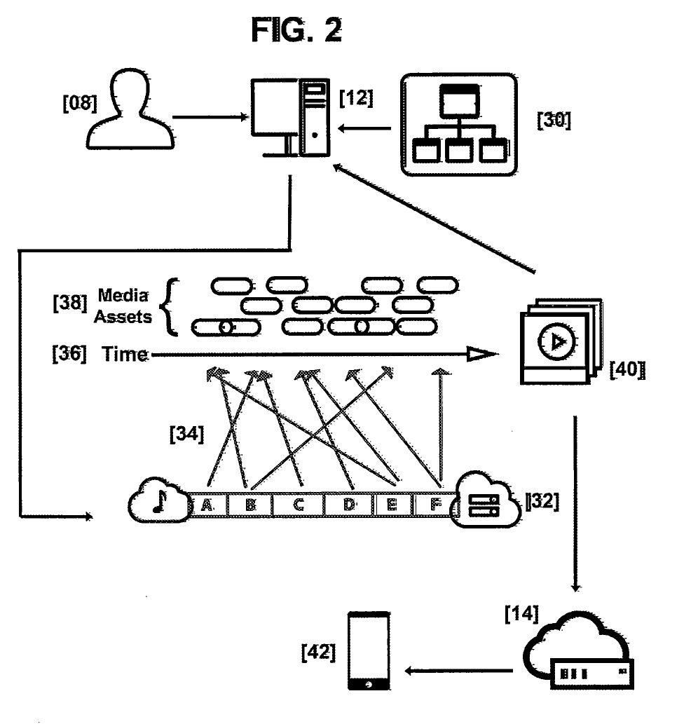

FIG. 2 illustrates diagrammatically multiple file types from multiple Cloud Service Providers mixed into multimedia Shows.

A user 08, accesses a computer interface 12, displaying the media file directory in Virtual Directory 30.

The user 08 rearranges, mixes, or combine the symbolic links in the Virtual Directory 30 to create multimedia Shows of sequential and/or concurrent media files.

In a specific embodiment, the symbolic links are visually reordered or mixed 34 by placing them along a virtual timeline 36. Enhancements can be added to individual media files or globally for all files in the show, such as, but not limited to, color correction, contrast, brightness, pixel smoothing, volume level, or special effects such transitions, zooming or timing.

In an embodiment, the Show includes the special effect of splitting the viewing screen into two or more screens, each showing visual media.

The Show is output as a Show Instruction file 40, which includes all of the instructions, links, special effects, security or other information required for viewing the Show.

The Show Instruction file 40 can be stored in a Cloud server and retrieved by a plurality of devices with media players capable of reading the file and playing the Show.

In an embodiment, the Show Instruction files reside on the Cloud Aggregation Server 14, which receives an instruction to stream the Show to the device. For example, a series of photos can be made into a playlist with each image showing for five seconds, with music from a subscription Cloud service playing during the slideshow, followed by a streaming video.

In an embodiment, a Universal Player 42 on a computing device with the necessary video and audio codecs, conforming to the specification of the individual Cloud's APIs is used for viewing.

The present invention can also push Shows out to media devices, such as kiosks, on a schedule. The Show Instruction File can use Boolean and Wildcards queries to create dynamically changing Shows as content is changed, removed or added in a plurality of Clouds Services.

For example, a real estate company has image files of homes stored with multiple Cloud Services around the world, with the content maintained by its various worldwide offices. A user can create a Show of homes for sale, using content from multiple Cloud Services Providers, which is then streamed on a schedule to media players at office locations. Changing referenced images in the Cloud will automatically change the associated image in the Show.

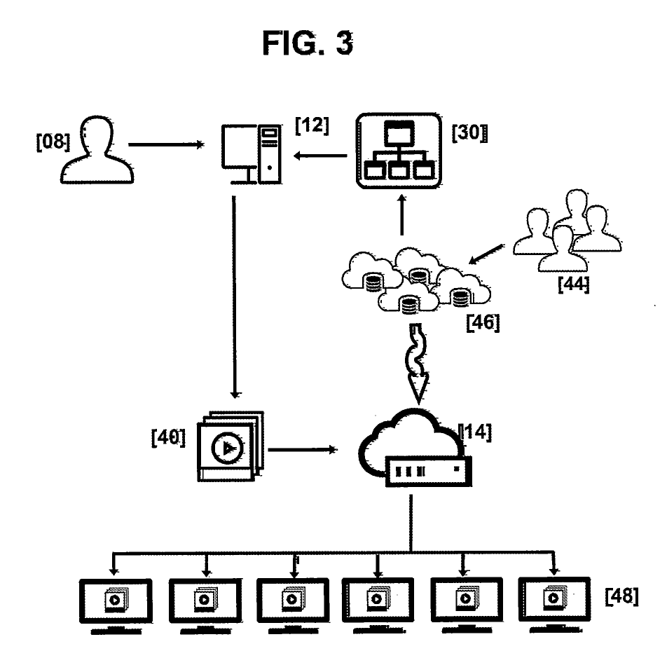

FIG. 3 illustrates generating dynamically changing Shows, which are pushed out to multiple local media players.

A user 08 accesses software device 12, which displays the Virtual Directory 30 from a plurality of Cloud Service Providers.

In one embodiment, the user 08 accesses a software interface 12 which allow the user to enter, but not limited to, Boolean or natural language search queries when creating a Show, allowing for ranges of content rather than single media files. For example, the user 08 could create a Show that includes any .jpg, .png, or .tif image file, residing in Clouds A, B and C, which are tagged with the word “Spain” in the metadata description field with each image being viewed in alphabetical order for five second each on a loop, with a crossfade transition between each image.

Users 44 can change or add media in a Cloud Service 46, which is then reflected in the Virtual Directory 30. During the next API call content update to that Cloud Service Provider, the Show 40 will change automatically to reflect the updated or content that results from the Show's search string, and streamed by Cloud Aggregation Server 14 to the media players 48.

In another embodiment, Show file attributes, such as visual enhancements or special effects, can be changed or added by instructions embedded in the media file, for example, in custom metadata fields.

While this invention has been described in conjunction with various examples and preferred embodiments, many alternatives, modifications and variations will be apparent to those skilled in the art. Accordingly, and examples as set forth above are intended to be illustrative but not limiting. Changes may be made without departing from the spirit and scope of the invention.

What is claimed is:

1) A computer-implemented method for aggregating files from multiple Cloud Service Providers into one or more virtual directories comprising:
a) providing an Internet connected Computing Device for requesting data from two or more Cloud Service Providers, which are external to the computing device;
b) providing a user interface to enter login information required for access to Cloud Services by the Computing Device.
c) causing said Computing Device to make an application program interface (API) call to two or more Cloud Service Providers, requesting paths to Cloud hosted files;
d) creating symbolic links designating the paths to files residing on the Cloud Server;
e) aggregating the symbolic links into one or more virtual directories; and
f) outputting the virtual directory to a graphical user interface on an internet connected computing device.

2) A method according to claim 1 wherein the files listed in the virtual directory are media files, selected from audio, video, image files and combinations thereof.

3) A method according to claim 2 wherein the Computing Device is an Aggregation Cloud Server external to one or more user devices with applications capable of playing streaming media.

4) A method according to claim 2 wherein a user selects a symbolic link from a virtual directory, a file selection notification is sent to a computing device which makes an API call to the Cloud server hosting the file indicated by the path in the symbolic link, whereby said file is streamed to a user's media player application.

5) A method according to claim 4, wherein a computing process removes one or more symbolic links pointing to duplicate files on one or more cloud servers.

6) A method according to claims 5, wherein one or more users store one or more preference profiles on a Cloud Server.

7) A method according to claim 6 wherein user requested streamed media content is played on a Universal player.

8) A method according to claim 7 wherein a Universal player commits saved-state information periodically or by user request, a plurality of times during playback of streaming media files, saving said saved-states to a Cloud Server, which can resume playback from a position recorded by a saved-state on another device containing a Universal player.

9) A method according to claim 2, wherein a user can create a Show by selecting two or more media files for sequentially ordered playback on a media player.

10) A method according to claim 9 wherein two or more media files are played concurrently.

11) A method according to claim 9 wherein a user adds special effects to a Show.

12) A method according to claim 10 wherein a user adds special effects to a Show

13) A method according to claim 11 where Shows are automatically generated based upon saved user preferences.

14) A method according to claim 12 where Shows are automatically generated based upon saved user preferences.

15) A method according to claim 7, wherein Show playback instructions are saved as a file to a Cloud server for playback on one or more devices capable of reading the Show instruction file.

16) A method according to claim 8, wherein Show playback instructions are saved as a file to a Cloud server for playback on one or more devices capable of reading the Show instruction file.

17) A method according to claim 9, wherein Show playback instructions are saved as a file to a Cloud server for playback on one or more devices capable of reading the Show instruction file.

18) A method according to claim 8 wherein a computing process requests media content and special effects according to playback instructions in a Saved Show file, makes API calls to Cloud Server's hosting media files required for playback, and streams the media to a plurality of media player devices.

19) A method according to claim 14 wherein the playback instruction from a saved Show Instruction file contain Boolean style queries for requesting media files for Show playback; sequential or concurrent playback order determined by a user or saved user preferences.
